(19) United States
(12) Patent Application Publication
(10) Pub. No.: US 2008/0276125 A1
(43) Pub. Date: Nov. 6, 2008

(54) Data Processing Method

(75) Inventors: Jens-Peter Akelbein, Bodenheim (DE); Rainer Wolafka, Bad Soden (DE)

Correspondence Address: IBM CORPORATION;ROCHESTER IP LAW DEPT. 917, 3605 HIGHWAY 52 NORTH, ROCHESTER, MN, 55901-7829, US

(73) Assignee: INTERNATIONAL BUSINESS MACHINES CORPORATION, Armonk, NY (US)

(21) Appl. No.: 12/114,058

(22) Filed: May 2, 2008

(30) Foreign Application Priority Data
May 3, 2007 (DE) 07107404.1

(51) Int. Cl. G06F 17/30; G06F 11/07

(52) U.S. Cl. 714/15; 707/102; 707/10; 707/E17.009; 707/E17.032; 714/E11.023

(57) ABSTRACT

The invention relates to a data processing method comprising generating meta-data for each data file stored by back-up servers of a set of back-up servers on a storage medium of a plurality of storage media. The meta-data of a data file comprises the file name of the data file, a content-specific identifier and an access path for the data file. The content-specific identifier relates to the data content comprised in the data file and the access path specifies on which storage medium on the plurality of storage media the data file is stored. The method further comprises storing the meta-data of each data file in a database, wherein the database enables the identification of data files having the same data content by use of the content-specific identifiers of the data files as these data files have identical content-specific identifiers.

### FIELD OF THE INVENTION

The invention relates to a data processing method which is adapted to increase the availability of data files stored on a library and the performance of the library.

### BACKGROUND

Storage pools for storing a large amount of data are mainly used for back-up purposes. A storage pool provides a plurality of storage media on which a large amount of data files can be stored. Examples of storage pools are grid storages, object storages, and automated tape libraries. A tape library is also referred to as tape silo or tape jukebox.

In order to manage and to maintain a storage pool, back-up clients and back-up servers are employed. The clients and the servers typically execute a storage management system such as for example IBM's Tivoli Storage Manager. A storage pool itself which is accessed by a back-up client via a back-up server running the storage management system does however not have any notion about the data files stored on the storage media of the storage pool and does also not have any information about the applications accessing the storage media. Usually, multiple back-up servers store data files on the storage pool independent from each other. Hence data files with identical data content are usually found on the storage media of the same storage pool. This might for example happen when a particular data file is distributed to different departments of a company, whereby the departments employ the same storage pool for storage purposes. When the back-up clients employed by the departments now independently and with eventually different policies perform back-ups via the back-up servers of the data files to the storage pool, the same data content might be written to the storage pool. As a result, data files having the same data content but which might differ with respect to the file names are potentially stored on multiple storage media of the storage pool. Hence a storage pool comprises redundancy with respect to the data files stored on the plurality of storage media provided by the storage pool as several files might have the same data content. It is an object of the invention to make use of the redundancy.

### SUMMARY OF THE INVENTION

According to a first aspect of the invention, there is provided a data processing method. In accordance with an embodiment of the invention, the data processing method comprises the step of generating meta-data for each data file stored by back-up servers of a set of back-up servers on a storage medium of a plurality of storage media. The meta-data of a data file comprises the file name of the data file, a content-specific identifier and an access path for the data file. The content-specific identifier relates to the data content comprised in the data file. The access path specifies on which storage medium of the plurality of storage media the data file is stored. In a further step the meta-data of each data file is stored in a database. The database enables the identification of data files having the same data content by use of the content-specific identifiers of the data files, because the content-specific identifiers of these data files are identical.

The back-up servers are usually employed by back-up clients to store data files on the storage media provided by a storage pool. With respect to each data file stored by a back-up server, meta-data of the data file is collected. The meta-data comprises the content-specific identifier. The content-specific identifier can be regarded as a fingerprint of the data content comprised in the corresponding data file. Two data files which have the same data content but which might differ in the file names are therefore associated with the same content-specific identifier. The method in accordance with the invention is therefore particularly advantageous as it allows identifying data files on the storage media that have identical data content by use of the meta-data.

The meta-data further comprises the access path. The access path specifies the location where the corresponding data file is found on the plurality of storage media.

In accordance with an embodiment of the invention, the data processing method further comprises the step of receiving a read request from a client via a first back-up server of the set of back-up servers. The read request is used to request a first data file having a first file name and a first access path. In a further step, it is determined if the first data file can currently be made available to the client via the first access path. If this is the case, the first data file is provided by use of a first access path to the client. If this is not the case, the database is accessed and the content-specific identifier of the first data file is determined by use of the first file name. Then, a second data file having the same content-specific identifier from the database is selected if such a second data file exists. The second data file has a second access path which can be made accessible for the client via the first back-up server in a quicker way than the first access path. The second data file is then provided instead of the first data file by use of the second access path to the client via the first back-up server.

The storage pool might for example be an automated tape library and the storage media might correspond to tape cartridges. The first file name with the first access path might for example be stored on a first tape cartridge which is mounted and in use by a second back-up server so that it cannot be made available immediately to the client via the first back-up server. The first file name can be used to identify the content-specific identifier by accessing the database if meta-data has been generated before with respect to the first data file. Once the content-specific identifier is known for the first data file, the database can be checked if a second data file exists which is associated with the same content-specific identifier which indicates that the second data file holds identical data content. If this is the case, the second access path of the second data file can be identified via the meta-data stored for the second data file and it can be checked if the second access path can be made accessible for the client in a quicker way than the first access path. The second access path might for example specify that the second data file is stored on a tape cartridge which is not mounted and used by another back-up server. The second data file can then be made available to the first back-up server and thus to the client instead of the first data file.

The method in accordance with the invention is therefore particularly advantageous as the data content comprised in the second data file which is identical to the data content comprised in the first data file is made available to the first back-up server and to the corresponding client in a quicker way. As a consequence, the overall performance of the storage pool is increased.

In accordance with an embodiment of the invention, the data processing method further comprises the step of receiving a restore request from a first back-up server of the set of back-up servers. The first back-up server requests for a client via the restore request to restore a first data file having a first file name. In a further step, the database is accessed and the content-specific identifier of the first data file is determined by use of the first file name. Then, a second data file having the same content-specific identifier is selected from the database. The second data file is accessible on the storage pool via a second access path which can be made available to the client via the first back-up server. In a further step, the second data file is provided by use of the second access path to the client.

It might well be that the first data file is not available anymore to the requesting client, for example when the storage media on which the first data file has been stored is corrupted. If the second data file can be identified from the database, the second access path might specify that the second data file is held on another storage medium which might not be corrupted. The second data file can then be made available to the client instead of the first data file. The method in accordance with the invention is particularly advantageous as it allows restoring data files by use of other data files that provide the identical data content and therefore contributes to increase of the reliability and fail-safe of the storage pool.

In accordance with an embodiment of the invention, the second data file is selected from a plurality of data files, wherein all data files of the plurality of data files relate to the same content-specific identifier. The second access path is an access path which can be made accessible for the client via the first back-up server in the quickest possible way with respect to the access paths of the other data files of the plurality of data files.

All data files of the plurality of data files hold the same data content as the first and second data files, and the second data file corresponds to the data file of the plurality of data files which can be made accessible to the client via the first back-up server in the quickest possible way. The method in accordance with the invention is therefore particularly advantageous as it allows optimizing the access speed to the data content held by the plurality of data files.

In accordance with an embodiment of the invention, the database holds first information, wherein the first information specifies which storage medium of the plurality of storage media is accessible for the client via the first back-up server. The first information is used to verify, if the second access path of the second data file is accessible for the first back-up server. The second data file is then only provided to the client via the first back-up server if the corresponding access path can indeed by accessed by the first back-up server. This contributes to the system stability as only data file with access paths that can indeed by accessed are provided to clients via the corresponding back-up servers.

In accordance with an embodiment of the invention, each back-up server of the plurality of back-up servers comprises a repository. The repository of a back-up server comprises second information about the data files stored by the back-up server on the plurality of storage media. The second information comprises the file name and the access path of each stored data file. The second information is employed for generating the meta-data for each data file stored by the back-up server.

Each back-up server therefore stores on its repository the file names and the access paths of the data files that have been stored by the back-up server.

In accordance with an embodiment of the invention, the access path of a data file provided by the second information is used to access the data file on the corresponding storage medium and the content-specific identifier is generated from the data content of the data file.

In accordance with an embodiment of the invention, the content-specific identifier corresponds to the output of a hash function applied to the data content of the data file.

In accordance with an embodiment of the invention, the data processing method further comprises the step of scanning the database and identifying a first content-specific identifier. The first content-specific identifier is only associated with a first data file having a first access path. The first access path indicates that the first data file is stored on a first storage medium of the plurality of storage media.

In a further step of the method in accordance with the invention, a copy of the first data file is stored on a second storage medium of the plurality of storage media. Then, the database is updated by storing meta-data generated for the copy in the database. The meta-data comprises the first content-specific identifier and a second access path for the copy, wherein the second access path specifies that the copy is stored on the second storage medium.

The method in accordance with the invention is therefore particularly advantageous as data files having a data content that is only stored once on the storage pool can be identified as the corresponding content-specific identifier only relates to a single data file in the database. In order to prevent any loss of data, copies of these data files are stored in the storage pool which contributes to enhance the reliability of the storage pool.

In accordance with an embodiment of the invention, the method further comprises the step of detecting the defect of at least a part of a storage medium of the plurality of storage media. In a further step, the meta-data in the database is used to determine a first set of data files, wherein the first set of data files relates to the data files stored on the defect part of the storage medium. The meta-data comprises the access paths of all data-files which have been stored on the defect part and which therefore allow for an identification of the first set of data files. According to a further step, the content-specific identifiers of these data files are used to identify a second set of data files. The data files of the second set of data files provide the same data content as the data files of the first set of data files. For example, the first set of data files comprises a first data file with the data content X, a second data file with the data content Y, and a third data file with data content Z. The second set of data files comprises then a fourth data file with data content X and which has the same content-specific identifier as the first data file, a fifth data file with data content Y and which has the same content-specific identifier as the second data file, and a sixth data file with data content Z and with a content-specific identifier which is equal to the content-specific identifier of the third data file. These data files are stored on uncorrupted media of the plurality of media and are used to recover the data files of the first set of data files. The method in accordance with the invention is therefore particularly advantageous as the data files stored on corrupted or defect storage media can be recovered. Thus, the reliability of the storage pool is greatly enhanced.

In accordance with an embodiment of the invention, the meta-data of a data file comprises further information relating to the data file. The further information relate for example, but not exclusively, to access rights of clients and/or back-up servers and/or users of the storage pool for the data file. The information can also comprise time stamps specifying the creation date, the modification date, and so on of the data file.

In accordance with an embodiment of the invention, the plurality of storage media is comprised in a grid storage or an object storage.

In accordance with an embodiment of the invention, the plurality of storage media relates to a plurality of tape cartridges, wherein the plurality of tape cartridges is comprised in an automated tape library.

According to a second aspect of the invention, there is provided a computer program product which comprises computer executable instructions. The instructions are adapted to perform the steps of the method in accordance with the invention.

According to third aspect of the invention, there is provided a data processing system. The data processing system has means for generating meta-data for each data file stored by back-up servers of a set of back-up servers on a storage medium a plurality of storage media. The meta-data of a data file comprises the file name of the data file, a content-specific identifier and an access path of the data file. A content-specific identifier relates to a data content comprised in the data file and the access path specifies on which storage medium of the plurality of storage media the corresponding data file is stored. The data processing system has also means for storing the meta-data of each data file in a database, wherein the database enables the identification of data files having the same data content by use of the content-specific identifiers of the data files as the content-specific identifiers of these data files are identical.

### BRIEF DESCRIPTION OF THE DRAWINGS

In the following embodiments of the invention will be described in greater detail by making reference to the drawings in which:

FIG. 1 shows a block diagram of a network comprising a client, back-up servers, and a tape library,

FIG. 2 shows a flow diagram illustrating steps of a method in accordance with the invention,

FIG. 3 shows a block diagram of a network comprising back-up servers and a tape library,

FIG. 4 provides an illustration of the meta-data stored in a database, and

FIG. 5 provides an illustration of other information stored in the database.

### DETAILED DESCRIPTION

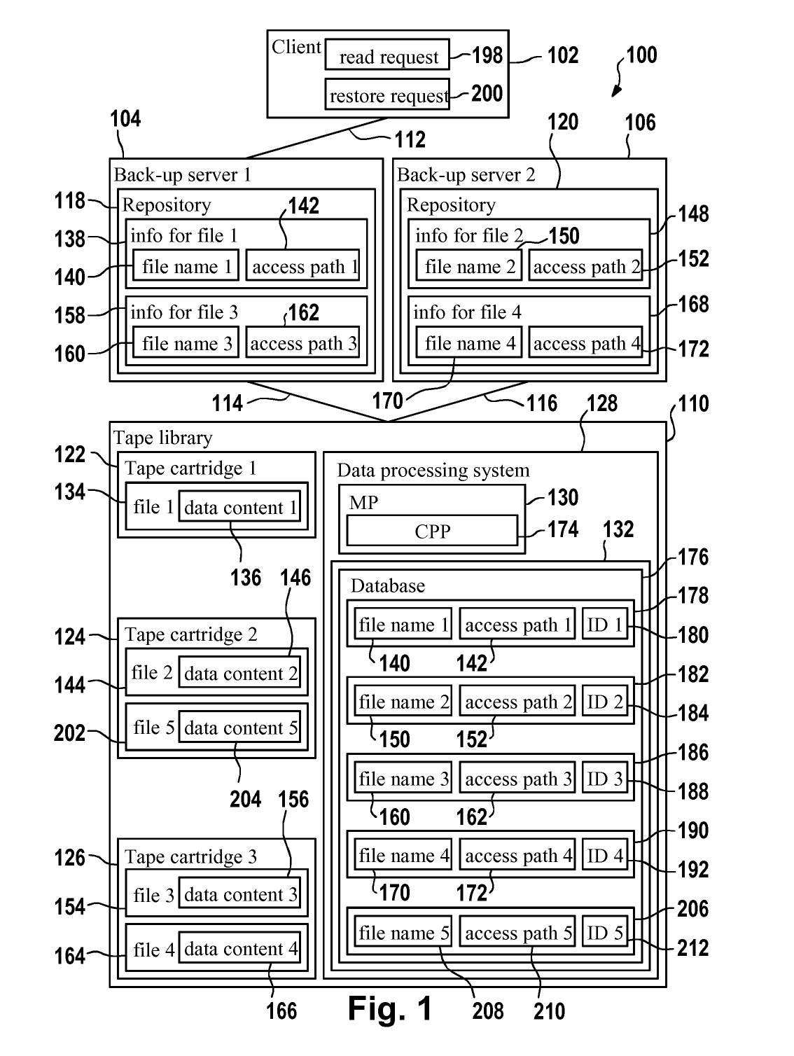

FIG. 1 shows a block diagram of a network 100. The network 100 comprises a client 102, a first back-up server 104, and a second back-up server 106. The network 100 further comprises a tape library 110.

The client 102 is for example connected with the first back-up server 104 via a network connection 112. The first back-up server 104 is connected with the tape library 110 via network connection 114 and the second back-up server 106 is connected with the tape library 110 via a network connection 116.

The first back-up server 104 comprises a repository 118 and the second back-up server 106 comprises a repository 120.

The tape library 110 comprises a first tape cartridge 122, a second tape cartridge 124, and a third tape cartridge 126. The tape library 110 further comprises a data processing system 128 which can be regarded as a computer system and which has a microprocessor 130 and a storage 132.

The first back-up server 104 stores data files on the tape cartridges of the tape library 110. For example, the first back-up server 104 might have stored a first data file 134 having the data content 136 on the first tape cartridge 122. When the first back-up server 104 performs the storing of the first data file 134 on the first tape cartridge 122, the first back-up server 104 stores information 138 for the first data file 134 on the repository 118. The information 138 comprises the file name 140 of the first data file 134 and the access path 142 for the first data file 134. The access path 142 specifies that the first data file 134 can be found on the first tape cartridge 122 and it also specifies where on the first tape cartridge 122 the corresponding file 134 can be found.

The second back-up server 106 has stored a second data file 144 with the data content 146 on the second tape cartridge 124. Further, the second back-up server 106 has stored information 148 for the second data file 144 on its repository 120. The information 148 comprises the file name 150 of the second data file 144 and the access path 152 which specifies that the second data file 144 is found on the second tape cartridge 124 and further the location of the second file 144 on the second tape cartridge 124.

Similarly, the first back-up server 104 has stored a third data file 154 on the third tape cartridge 126. The third data file comprises data content 156. The first back-up server 104 has further stored information 158 about the third data file 154 on its repository 118. The information 158 comprises the file name 160 of the third data file 154 as well as the access path 162 of the third data file 154.

The second back-up server 106 has further stored a fourth data file 164 on the third tape cartridge 126, whereby the fourth data file 164 has data content 166. The back-up server 106 has further stored information 168 comprising the file name 170 of the fourth data file 164 and the access path 172 to the fourth data file 164 on its repository 120.

The microprocessor 130 of the data processing system 128 executes a computer program product 174. In operation, the computer program product 174 initiates the scanning of the repository 118 and the repository 120 so that the information 138, the information 158, the information 148, and the information 168 become available to the data processing system 128. The computer program product 174 maintains a database 176 on the storage 132. For each information obtained from scanning the repository 118 and 120, the computer program product 174 generates an entry in the database 176.

An entry 178 relates to the information 138 for the first data file 134. The entry 178 comprises the file name 140 and the access path 142 as well as a content-specific identifier 180 for the data content 136 of the first data file 134. The content-specific identifier 180 corresponds to a fingerprint generated from the data content 136. For this, the computer program product 174 accesses the first data file 134 which is possible because the computer program product 174 knows the access path 142 to the first data file 134 and applies for example a hash function to the data content 136. The output of the hash function is then taken as the content-specific identifier 180.

Similarly, the computer program product 174 generates an entry 182 with respect to the information 148 for the second data file 144. The entry 182 comprises the file name 150, the access path 152 as well as a content-specific identifier 184 which is generated from the data content 146, by applying the hash function to the data content 146.

The computer program product 174 further generates an entry 186 in the database 174 with respect to the information 158, whereby the entry 186 relates to the third data file 154. The entry 186 comprises the file name 160 and the access path 162. Further a content-specific identifier 188 is generated from the data content 156. Similarly, an entry 190 is generated after the computer program product 174 has gotten knowledge about information 168. The entry 190 comprises the file name 170 and the access path 172 as well as a content-specific identifier 192 which is generated from the data content 166.

The computer program product 174 might scan the repositories 118 and 120 regularly so that the database 176 comprises entries that are up to date and reflect the information stored on the repositories 118 and 120. Further, the tape cartridges 122-126 might be accessed in order to determine the content-specific identifier for a file during idle times of the tape library 110, for example at night when the load on the tape library 110 caused by accesses of the back-up servers 104 and 106 is reduced.

The client 102 might send a read request 198 via the network connection 112 to the first back-up server 104. The read request 102 might be used to request the back-up server 104 to provide the data file 134 to the client 102. The data file 134 is specified in the request 198 by use of the corresponding file name 140. The back-up server 104 is able to determine by use of the file name specified in the read request 138 and by use of the information 138 that the first file 134 is stored under the first access path 142. The back-up server 104 therefore further processes the read request 198 to the library 110 requesting the tape library to mount the first tape cartridge 122 and to therefore make the first tape cartridge 122 available to the first back-up server 104 in order to be able to read out the first file 134.

The read request 198 is received by the data processing system 128. The computer program product 174 determines if the first tape cartridge 122 is already mounted for the first back-up server 104, because if this is the case the first back-up server 104 can immediately read out the first data file 134 and provide the first data file 134 to the client 102. However, if the tape cartridge 122 is not mounted for the back-up server 104, the computer program product 174 accesses the database 176 and is able by use of the file name 140 to determine that the first data file relates to the content-specific identifier 180.

In the following it is assumed that the data content 136 and the data content 146 of the first file 134 and the second file 144 match though the file names 140 and 150 might be different. Hence, the content-specific identifier 184 matches the content-specific identifier 180 and the computer program product 174 is able to identify by scanning the database 176 that the second data file 144 provides the same data content 146 as the first data file 124.

The computer program product 174 then determines if the second tape cartridge 124 can be made available to and can be mounted by the first back-up server 104 in a quicker way than the first tape cartridge 122. The first tape cartridge 122 might for example be mounted by the second back-up server 106 and therefore be blocked, while the second tape cartridge 124 could immediately be mountable by the first back-up server 104. If the second data file 144 can indeed be made available to the first back-up server 104 in a quicker way, the second data file 144 is provided to the back-up server 104 and thus to the client 102 instead of the first data file 134.

The client 102 might further send a restore request 200 to the back-up server 104 requesting to restore the first data file 134 which might not be readable by the client 102 when the tape cartridge 122 is mounted for the first back-up server 104. The restore request 200 is read by the computer program product 174 which is by use of the database 176 able to determine that the second file 144 provides the identical data content 146 than the first file 134 (the data content 146 matches the data content 136 as mentioned before). The second data file 144 is then provided to the back-up server 104 and therefore made available to the client 102 as a replacement for the first data file 134.

The computer program product 174 can be further adapted to scan the database 176 in order to determine if there is only one data file with a specific content-specific identifier. For example, only the entry 186 might comprise the content-specific identifier 188. Thus, the content-specific identifiers 180, 182, 192 differ from the content-specific identifier 188. This is an indication that the data content 156 of the data file 154 is only stored once in the tape library 110. In response to the detection that only a single data file is associated with the content-specific identifier 188, a fifth data file 202 having a data content 204 which is equal to the data content 156 is stored by the computer program product 174 on another tape cartridge, for example as shown in FIG. 1 on the second tape cartridge 124. Furthermore, the computer program product 174 generates an entry 206 for the data file 202. The entry 206 comprises the file name 208 of the fifth data file, the access path 210 of the fifth data file and a content-specific identifier 212 for the fifth data file which matches the content-specific identifier 188 as the data content 204 equals the data content 156.

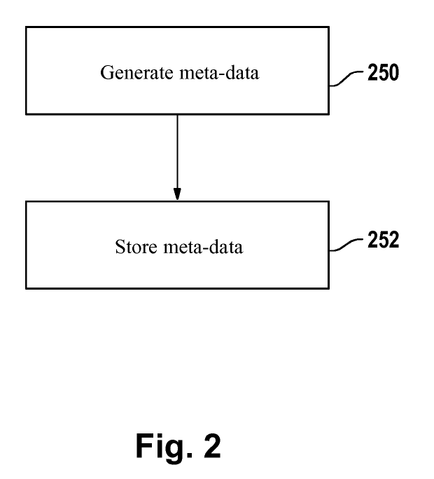

FIG. 2 shows a flow diagram illustrating steps of a data processing method in accordance with the invention. According to step 250 of the data processing method, meta-data is generated for each data file stored by back-up servers of a set of back-up servers on a storage medium of a plurality of storage media. The meta-data of a data file comprises the file name of the data file, a content-specific identifier and an access path for the data file. The content-specific identifier relates to the data content comprised in the data file and the access path specifies on which storage medium of the plurality of storage media the data file is stored. According to step 252 of the method in accordance with the invention, the meta-data of each data file is stored in a database. The database enables the identification of data files which have the same data content by use of the content-specific identifiers of the data files as the content-specific identifiers of these data files are identical.

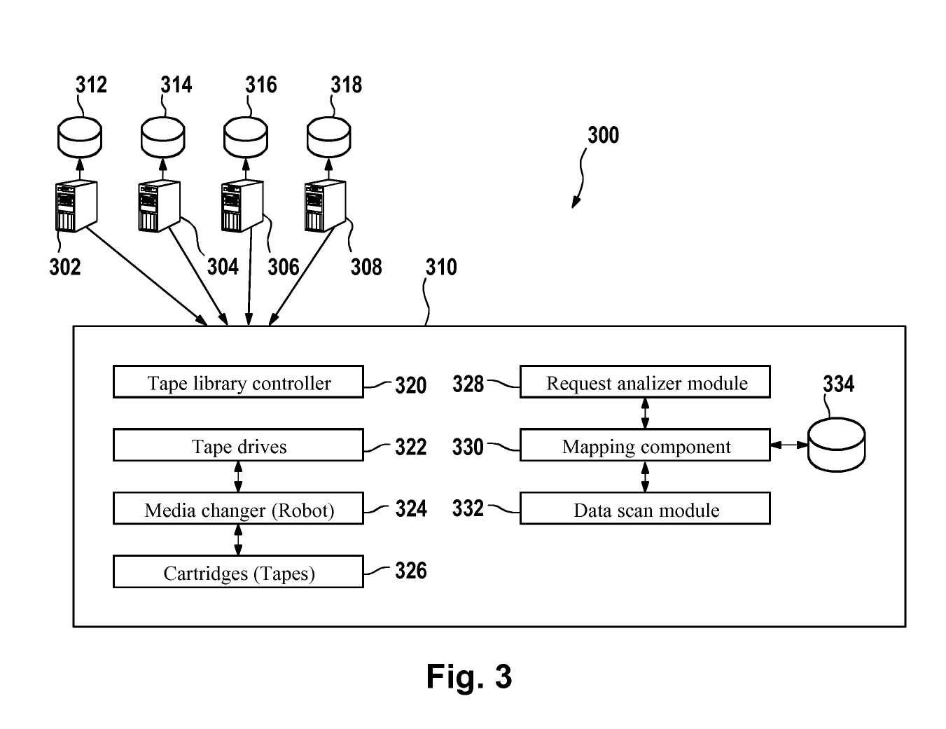

FIG. 3 shows a block diagram of a network 300 comprising back-up servers 302, 304, 306, and 308 and an automated tape library 310. Each of the back-up servers 304-308 comprises a repository 312, 314, 316, and 318, respectively on which the corresponding data server stores information about the data files stored by the data server on the automated tape library 310.

The automated tape library 310 comprises a tape library controller 320 to process client requests, received via one of the back-up servers 302-308, and tape drives 322. The tape library 310 further comprises a media changer 324 and a plurality of tape cartridges 326 which are also referred to simply as tapes or cartridges. The media changer 324 can be regarded as a robot that is controlled by the tape library controller 320 and that is used to put a tape cartridge from the plurality of tape cartridges 326 from the ‘shelf’ where the tape cartridges 326 are stored into one of the tape drives 322 in order to make the tape cartridge accessible for a back-up server.

The tape library 310 further comprises a request analyzer module 328, a mapping component 330 and a data scan module 332.

The data scan module 332 is adapted to query the repositories 312-318 of the back-up servers 302-308 in order to determine what data files are stored on the plurality of cartridges 326 and in order to obtain the file names and access paths of these data files. The content of the data files held on the cartridges 326 can then be used as an input of a hash function such that for each data file a content-specific identifier can be determined.

The meta-data of each data file which comprises the corresponding content-specific identifier and the file name as well as the access path of the file is then transferred from the data scan module 332 to the mapping component 330. The mapping component 330 is linked with a repository 334 on which the mapping component 330 maintains a database. The mapping component 330 stores the meta-data received from the data scan module 332 in the database on the repository 334.

The data scan module 332 can query the back-up servers 302-308 based on certain policies, such as daily when no back-up jobs are running or during idle times. It is further possible to query one of the back-up servers 302-308 at a time or a selection of the back-up servers or all back-up servers at a time.

The request analyzer module 332 analyzes a request received from one of the back-up servers via the tape library controller 320 and determines if the request can be serviced immediately. If this is the case, the mount of the cartridge on which the requested data file is stored will be initiated by the tape library controller 320. If this is not the case, the request analyzer module 328 queries the database of the repository 334 in order to determine if there is another data file which provides the same data content as the requested data file. That is, the request analyzer module 328 determines by use of the file name of the requested data file the content-specific identifier of this data file and scans the database for another file that has the same content-specific identifier. The request analyzer module 328 also knows which of the tape drives can be accessed by the back-up server that has sent the request and can select the other data file accordingly. The other data file can then be restored and made available to the requesting back-up server in a quicker way then the data file requested initially by use of the request. Thus, the overall performance of the library 310 can be increased by use of the method in accordance with the invention.

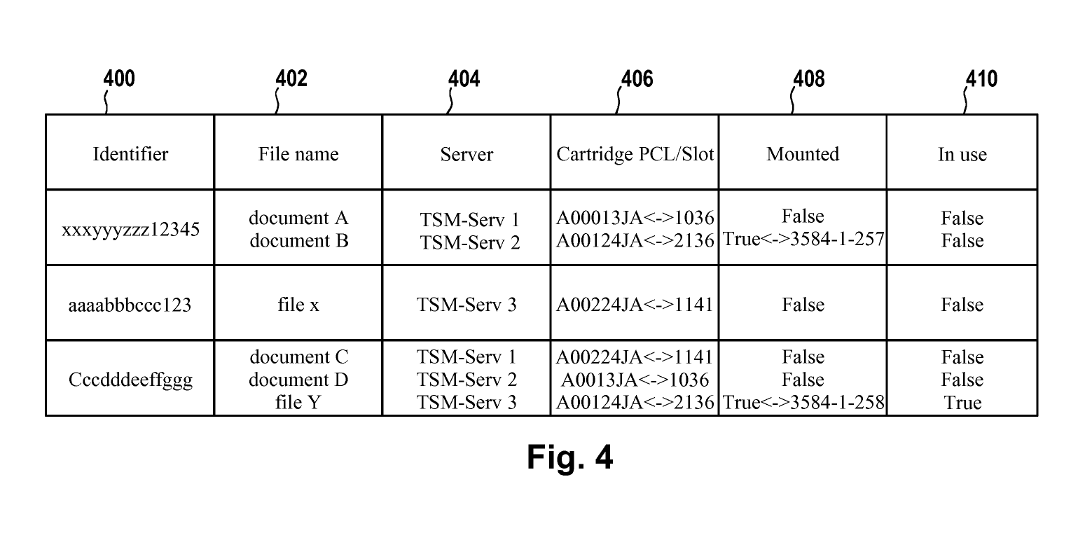

FIG. 4 provides an illustration of the meta-data stored in a database. In the database, the meta-data is stored in form of a table. The table comprises a column 400 for the content-specific identifier of the corresponding data file, a column 402 for the file name of the corresponding data file, a column 404 specifying the server which has stored the corresponding data file on the library, a column 406 specifying the access path of the corresponding data file, a column 408 in which it is specified if the tape cartridge on which the corresponding data file is stored is actually mounted or not and a column 410 which specifies if the actual tape cartridge is in use or not.

For example, the data file having the file name ‘document A’ (see column 402) has the content-specific identifier as given in column 400 and has been stored by a back-up server called TSM-Serv 1 as given in column 404. The corresponding access path of the data file with the file name ‘document A’ is given in column 406. As can be seen from column 408, the tape cartridge is currently not mounted and as can be seen from column 410, the cartridge is currently not in use.

Further it can be seen from FIG. 4 that the data file bearing the name ‘document B’ is associated with the identical content-specific identifier 400, see column 400. Thus, this data file provides the same data content and could be used instead of the previous mentioned document for the provision of the identical data content to a requesting client or in order to restore the previous mentioned document in case this document is corrupted.

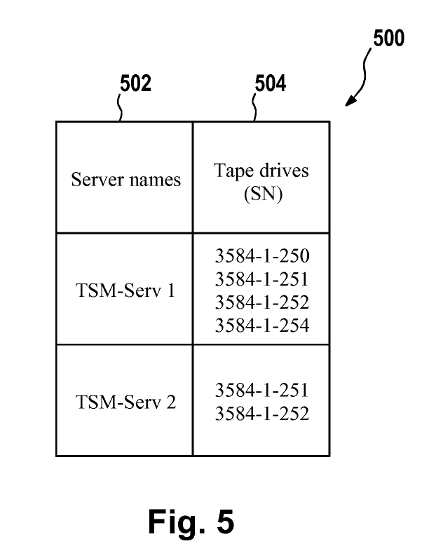

FIG. 5 provides an illustration of further information 500 stored on the database, e.g., on database 176 of FIG. 1. The information 500 specifies which back-up server is able to access which tape drive. The information 500 is provided in a tabulated way, wherein the first column 502 relates to the server names, and wherein the second column 504 specifies the tape drives via their serial numbers (SN) which can be accessed by the corresponding server listed in the first column 502. The information 500 is employed in order to ensure that a data file which is provided to a requesting back-up server as a replacement of another data file can be accessed by the back-up server.

What is claimed is:

1. A data processing method comprising:
generating meta-data for each data file stored by back-up servers of a set of back-up servers on a storage medium of a plurality of storage media, the meta-data of a data file comprising the file name of the data file, a content-specific identifier and an access path for the data file, the content-specific identifier relating to the data content comprised in the data file, the access path specifying on which storage medium of the plurality of storage media the data file is stored;
storing the meta-data of each data file in a database, the database enabling the identification of data files having the same data content by use of the content-specific identifiers of the data files, the content-specific identifiers of these data files being identical.

2. The method according to claim 1, further comprising:
receiving a read request from a first back-up server of the set of back-up servers, the first back-up server requesting for a client via the read request a first data file having a first file name and a first access path;
determining if the first data file can currently be made available to the client via the first access path;
providing the first data file by use of the first access path, if the first data file can currently be made available to the client via the first access path;
accessing the database and determining the content-specific identifier of the first data file by use of the first file name, if the first data file can currently not be made available to the client via the first access path;
selecting a second data file having the same content-specific identifier from the database, the second data file having a second access path, the second access path can be made accessible for the client via the first back-up server in a quicker way than the first access path;
providing the second data file instead of the first data file by use of the second access path to the client.

3. The method according to claim 1, further comprising:
receiving a restore request from a first back-up server of the set of back-up servers, the first back-up server requesting for a client via the restore request to restore a first data file having a first file name;
accessing the database and determining the content-specific identifier of the first data file by use of the first file name;
selecting a second data file having the same content-specific identifier from the database, the second data file having a second access path, the second access path can be made accessible for the client via the first back-up server;
providing the second data file by use of the second access path to the client.

4. The method according to claim 3, further comprising selecting the second data file from a plurality of data files, all data files of the plurality of data files relating to the same content specific identifier, the second access path being the access path which can be made accessible for the client via the first back-up server in the quickest possible way with respect to the access paths of the other data files of the plurality of data files.

5. The method according to claim 4, wherein the database holds first information, the first information specifying which storage medium of the plurality of storage media is accessible for the first back-up server, wherein the first information is used to verify if the second access path of the second data file is accessible for the first back-up server.

6. The method according to claim 5, wherein each back-up server of the plurality of back-up servers comprises a repository, wherein a repository of a back-up server comprises second information about the data files stored by the back-up server on the plurality of storage media, wherein the second information comprises the file name and the access path of each stored data file, wherein the second information is employed for generating the meta-data for each data file stored by the back-up server.

7. The method according to claim 6, wherein the access path of a data file provided by the second information is used to access the data file on the corresponding storage medium, wherein the content-specific identifier is generated from the content of the data file.

8. The method according to claim 7, wherein the content-specific identifier corresponds to the output of a hash function applied to the content of the data file.

9. The method according to claim 1, further comprising:
scanning the database and identifying a first content-specific identifier, wherein only a first data file is related to the first content-specific identifier, the first data file being stored on a first storage medium of the plurality of storage media;
storing a copy of the first data file on a second storage medium of the plurality of storage media;
updating the database by storing meta-data generated for the copy in the database, the meta-data comprising the first content-specific identifier and an access path for the copy, the access path specifying that the copy is stored on the second storage medium.

10. The method according to claim 1, further comprising:
detecting the defect of at least a part of a storage medium of the plurality of storage media;
using the meta-data to determine a first set of data files, the first set of data files relating to the data files stored on the defect part of the storage medium;
using the content-specific identifiers of these data files in order to identify a second set of data files, the data files of the second set of data files providing the same data content as the data files of the first set of data files, the data files of the second set of data files being not stored on the defect part;
using the second set of data files to restore the first set of data files.

11. The method according to claim 10, wherein the plurality of storage media is comprised in a grid storage or an object storage.

12. The method according to claim 10, wherein the plurality of storage media relates to a plurality of tape cartridges, wherein the plurality of tape cartridges is comprised in an automated tape library.

13. A computer program product comprising computer executable instructions, the instructions being adapted to perform the method according to claim 1.

14. A data processing system comprising:
means for generating meta-data for each data file stored by back-up servers of a set of back-up servers on a storage medium of a plurality of storage media, the meta-data of a data file comprising the file name of the data file, a content-specific identifier and an access path for the data file, the content-specific identifier relating to the data content comprised in the data file, the access path specifying on which storage medium of the plurality of storage media the data file is stored;
means for storing the meta-data of each data file in a database, the database enabling the identification of data files having the same data content by use of the content-specific identifiers of the data files, the content-specific identifiers of these data files being identical.

15. The data processing system according to claim 14, further comprising:
means for receiving a read request from a first back-up server of the set of back-up servers, the first back-up server requesting for a client via the read request a first data file having a first file name and a first access path;
means for determining if the first data file can currently be made available to the client via the first access path;
means for providing the first data file by use of the first access path, if the first data file can currently be made available to the client via the first access path;
means for accessing the database and determining the content-specific identifier of the first data file by use of the first file name, if the first data file can currently not be made available to the client via the first access path;
means for selecting a second data file having the same content-specific identifier from the database, the second data file having a second access path, the second access path can be made accessible for the client via the first back-up server in a quicker way than the first access path;
means for providing the second data file instead of the first data file by use of the second access path to the client.

16. The data processing system according to claim 14, further comprising:
means for receiving a restore request from a first back-up server of the set of back-up servers, the first back-up server requesting for a client via the restore request to restore a first data file having a first file name;
means for accessing the database and determining the content-specific identifier of the first data file by use of the first file name;
means for selecting a second data file having the same content-specific identifier from the database, the second data file having a second access path, the second access path can be made accessible for the client via the first back-up server;
means for providing the second data file by use of the second access path to the client.

17. The data processing system according to claim 16, further comprising means for selecting the second data file from a plurality of data files, wherein all data files of the plurality of data files relate to the same content specific identifier, wherein the second access path is the access path which can be made accessible for the client via the first back-up server in the quickest possible way with respect to the access paths of the other data files of the plurality of data files.

18. The data processing system according to claim 14, further comprising:
means for scanning the database and identifying a first content-specific identifier, wherein only a first data file is related to the first content-specific identifier, the first data file being stored on a first storage medium of the plurality of storage media;
means for storing a copy of the first data file on a second storage medium of the plurality of storage media;
means for updating the database by storing meta-data generated for the copy in the database, the meta-data comprising the first content-specific identifier and an access path for the copy, the access path specifying that the copy is stored on the second storage medium.

19. The data processing system according to claim 14, further comprising:
means for detecting the defect of at least a part of a storage medium of the plurality of storage media;
means for using the meta-data to determine a first set of data files, the first set of data files relating to the data files stored on the defect part of the storage medium;
means for using the content-specific identifiers of these data files in order to identify a second set of data files, the data files of the second set of data files providing the same data content as the data files of the first set of data files, the data files of the second set of data files being not stored on the defect part;
means for using the second set of data files to restore the first set of data files.
